(19) United States
(12) Patent Application Publication
(10) Pub. No.: US 2011/0251964 A1
(43) Pub. Date: Oct. 13, 2011

(54) Pricing Guaranteed Delivery Contracts in Online Display

(76) Inventors: Jayavel Shanmugasundaram, Santa Clara, CA (US); Vijay Bharadwaj, Sunnyvale, CA (US); Erik Yee, San Mateo, CA (US)

(21) Appl. No.: 12/759,434

(22) Filed: Apr. 13, 2010

(51) Int. Cl. G06Q 30/00; G06Q 10/00

(52) U.S. Cl. 705/80; 705/14.43; 705/14.69

(57) ABSTRACT

A method for pricing a contract for serving advertisements in an online display advertising environment comprising receiving a subject contract, the subject contract having at a target predicate for matching to a user visit, then forecasting, using a computer-based forecasting module, a set of user visits eligible to be served to the subject contract, wherein eligibility is based on matching the target predicate to a user visit (which user visit may be associated with an event predicate). Having a set of forecasted (matching) user visits, the method proceeds to select a set of eligible historical contracts that would be eligible to be served to the forecasted user visits. Finally, having a set of eligible historical contracts that would be eligible to be served to the target predicate, a curve fitting technique yields a price for the subject contract that minimizes the error in the price relative to expected user visits.

### FIELD OF THE INVENTION

The present invention relates generally to advertising, more specifically to techniques for optimization of prices of guaranteed advertisement contracts for Internet display advertising.

### BACKGROUND OF THE INVENTION

Advertising over the Internet seeks to reach individuals within a target set having very specific target predicates (e.g. male, age 40-48, graduate of Stanford, living in California or New York, etc). This targeting of very specific demographics is in significant contrast to print and television advertisements that are generally capable only to reach an audience within some broad, general demographics (e.g. living in the vicinity of Los Angeles, or living in the vicinity of New York City, etc).

In guaranteed display advertising, advertisers can buy guaranteed delivery contracts that specify targeted user visits (e.g. Males in California who visit Sports pages), a future duration for the contract (e.g. June-August 2010), and the number of user visits they are interested in obtaining (e.g. 100 million), and Internet publishers guarantee these contracts months in advance of the delivery date. Guaranteed display advertising is a multi-billion dollar industry and thus, intelligent pricing of guaranteed delivery contracts has a direct impact on publishers' revenue.

Unfortunately, the problem of intelligent pricing of guaranteed delivery contracts in online display advertising exhibits at least two characteristics that, when taken together, render legacy pricing methods inadequate. First, the guaranteed delivery contracts are priced and sold months in advance of any actual delivery of advertising, which means that the seller and buyer are forced to agree on a pricing model based on a guess or a projection. Secondly, the inventory that is sold to guaranteed contracts—user visits—is very high-dimensional in nature, having hundreds of possible attributes, and advertisers can potentially buy any of the potentially trillions of combinations of these attributes. Consequently, traditional pricing techniques such as real-time or combinatorial auctions, or optimization-based pricing based on self- and cross-elasticities, have proven to be inadequate for solving problems of this sort.

Accordingly, there exists a need for techniques for overcoming the abovementioned and other limitations of pricing guaranteed delivery contracts in online display advertising.

### SUMMARY OF THE INVENTION

A method for pricing a contract for serving advertisements in an online display advertising environment comprising receiving a subject contract, the subject contract having a target predicate for matching to a user visit, then forecasting, using a computer-based forecasting module, a set of user visits eligible to be served to the subject contract wherein eligibility is based on matching the target predicate to a user visit (which user visit may be associated with an event predicate). Having a set of forecasted (matching) user visits, the method proceeds to select a set of eligible historical contracts that would be eligible (or would have been eligible) to be matched to the forecasted user visits for guaranteed advertising delivery. Finally, having a set of eligible historical contracts that would be eligible to be served, a curve fitting technique is applied to yield a price for the subject contract that minimizes the error in the prices relative to expected user visits.

In one aspect, prices of historical contracts may be based on an updated historical contracts price calculation, effectively pricing the historical contracts according to a calculation performed with forecasted user visits that are time-shifted into a timeframe corresponding to a matching contract.

### BRIEF DESCRIPTION OF THE DRAWINGS

A brief description of the drawings follows:

FIG. 1 depicts an advertising server network environment including modules for pricing guaranteed delivery contracts in online display advertising, according to one embodiment.

FIG. 2 is a depiction of an exemplary data structure of a supply object, according to one embodiment.

FIG. 3A is a depiction of an exemplary data structure of a demand object, according to one embodiment.

FIG. 3B is a depiction of an exemplary data structure of a demand object, according to another embodiment.

FIG. 4 shows an index with target predicates in the form of an inverted index, according to one embodiment.

FIG. 5 depicts a portion of an advertising server network environment including modules for pricing guaranteed delivery contracts in online display advertising, according to one embodiment.

FIG. 6 shows a method for pricing guaranteed delivery contracts in an online display advertising environment, according to one embodiment.

FIG. 7 depicts a block diagram of a method for pricing a subject contract in online display advertising, according to one embodiment.

FIG. 8 depicts a block diagram of a system to perform certain functions of an advertising server network, according to one embodiment.

FIG. 9 is a diagrammatic representation of a network including nodes for client computer systems, nodes for server computer systems, and nodes for network infrastructure, according to one embodiment.

### DETAILED DESCRIPTION

Guaranteed delivery contracts are sold months in advance of the delivery date, and at various points during a given time period. For instance, it is not uncommon for an advertising agent to sell guaranteed delivery contracts long in advance (e.g. a year in advance, sometimes more) to some advertisers, a few months in advance to some other advertisers, and just a few days in advance to other advertisers. Second, each user visit can be described by hundreds (or even thousands or more) of attribute values, and advertisers can potentially target (and hence require the publisher to price) any of the potentially trillions of combinations of these attribute values. For instance, each user visit is typically characterized by the demographics of the user (e.g. age, gender, location, etc), explicitly stated interests of the user (e.g. travel, sports), implicitly inferred interests of the user (e.g. planning a vacation), characteristics of the web page being visited (e.g. Sports page, Travel page), characteristics of the system being used by the user (e.g. PC vs. mobile, dial-up vs. broadband, IP address location), and so on. Given these attributes, different advertisers may target different combinations; for instance, one advertiser may target Males in California who visit Sports pages, while another advertiser may target users between 20 and 30 years of age who are planning a vacation.

Consider the legacy method of online advertising in real-time auctions: Since guaranteed delivery contracts are sold well in advance, and at different points in time, they are not amenable to auctions because not all advertisers buy inventory during the same period of time (in this sense, it is analogous to airline ticket pricing, where not all passengers can be forced to buy tickets during the same period of time). As another example, consider traditional yield optimization methods used in the context of industries such as airlines and retail. Such methods typically model the quantity of demand at various price points, and compute self- and cross-elasticities of demand to optimize for the product prices (over a time period) such that revenue is maximized. However, computing self- and cross-elasticities of demand is only viable when a relatively small number of products (say, hundreds of products) are involved. Computing cross-elasticities for trillions of products is computationally intensive, and often impractical. Another possible (although often inadequate) pricing optimization method is to use combinatorial auctions, whereby different buyers can specify different combinations of inventory of interest (similar to different target combinations), and the problem is to find a way to allocate the inventory to buyers so as to maximize the yield. This method is not directly applicable to the problem of pricing guaranteed contracts because not all advertisers specify their requirements during the same time period. Further, such techniques typically have some computational bounds that limit application of combinatorial auctions to pricing guaranteed contracts that involve products having only tens (or possibly hundreds) of attributes.

### Overview of Networked Systems for Online Advertising

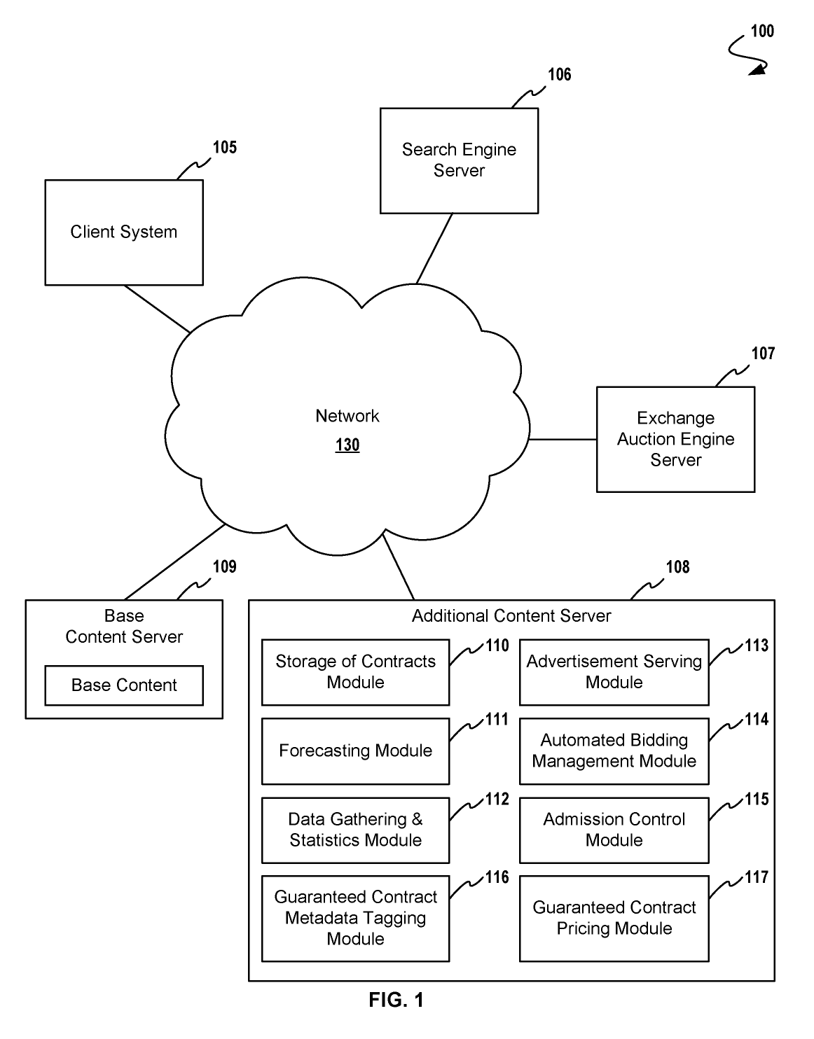

FIG. 1 depicts an advertising server network environment including modules for pricing guaranteed delivery contracts in online display advertising. The advertising server network environment implements a system for delivery of display advertising, including delivery of display advertising in a commercial environment involving pre-priced guaranteed delivery contracts. In the context of Internet advertising, placement of advertisements within a commercial environment involving pre-priced guaranteed delivery contracts via the Internet (e.g. environment 100 of FIG. 1) has become common. By way of a generalized example, an Internet advertiser may select a particular property (e.g. Yahoo.com/Finance, or Yahoo.com/Search), and may create an advertisement such that whenever any Internet user, via a client system 105, renders the web page from the selected property, possibly using a search engine server 106, the advertisement is composited on a web page by one or more servers (e.g. base content server 109, additional content server 108) for delivery to a client system 105 over a network 130. Given this generalized delivery model, and using techniques disclosed herein, sophisticated online advertising might be practiced. More particularly, an advertising campaign might include highly-customized advertisements delivered to a user corresponding to highly-specific target predicates. Again referring to FIG. 1, an Internet property (e.g. a publisher hosting the publisher's base content on a base content server 109) might be able to measure (and/or predict) the number of visitors that have any arbitrary characteristic, demographic, target predicate(s), or attribute(s), possibly using an additional content server 108 in conjunction with a data gathering and statistics module 112. Thus, an Internet user might be ‘known’ in quite some detail as pertains to a wide range of target predicates or other attributes.

An advertiser might enter into a contract (e.g. with the Internet property, or with an advertising agency, or with an advertising network, etc) to purchase the desired spots for some time duration (e.g. all top spots in all impressions of the web page empirestate.com/hotels for all of 2010). Such an arrangement, and variants as used herein, is termed a contract. And, when the parties to the contract agree on terms and conditions including a specific delivery schedule (e.g. reach one million Yahoo! users during December), the contract is termed a guaranteed delivery contract.

In embodiments of the systems within environment 100, components of the additional content server perform processing such that, given an advertisement opportunity (e.g. an event predicate), processing determines which (if any) contract(s) match the advertisement opportunity. In some embodiments, the environment 100 might host a variety of modules to serve management and control operations (e.g. a auction engine server 107, a storage of contracts module 110, a forecasting module 111, a data gathering and statistics module 112, an advertisement serving module 113, an automated bidding management module 114, an admission control module 115, a guaranteed contract metadata tagging module 116, a guaranteed contract pricing module 117, etc) pertinent to serving advertisements to users, including serving ads under guaranteed delivery terms and conditions. In particular, the modules, network links, algorithms, assignment techniques, serving policies, and data structures embodied within the environment 100 might be specialized so as to perform a particular function or group of functions reliably while observing capacity and performance requirements. For example, an additional content server 108, possibly in conjunction with a guaranteed contract metadata tagging module 116, and a guaranteed contract pricing module 117, might be employed to implement a system for pricing guaranteed delivery contracts in online display advertising. In some embodiments, a guaranteed contract metadata tagging module 116 might perform operations at any moment in time, possibly in asynchrony with operations performed by a guaranteed contract pricing module 117. For example, a guaranteed contract metadata tagging module 116 might perform operations in a batch-oriented (e.g. offline) mode, while the operations performed by a guaranteed contract pricing module 117 might be performed in an on-demand (e.g. online) mode.

### Pricing Based on Forecasted Supply

Pricing a contract based on forecasted supply attempts to price each contract based on the value of the individual user visits that are expected to be delivered to the contract (which expectation might be forecasted using a forecasting module 111).

As will readily become apparent, using forecasted individual user visits in the pricing model has several advantages over looking at only similar/identical contracts. First, it helps solve the problem of dealing with trillions of overlapping products. That is, by mapping each product to (a sample of) the set of user visits that are eligible (by virtue of the user's demographics) to receive an impression having an advertisement corresponding to the contract to be priced for a product, the overlap and intersection between the various products is ‘built in’ to the model. Second, pricing a contract based on forecasted supply helps solve the sparsity problem, i.e. the problem of pricing contracts that have very few or no other contracts with identical target predicate combinations.

As an example, consider the problem of pricing an exemplary contract that targets “Computer Scientists living in Raleigh”. A contract-wise pricing model might price this contract based on a complex target predicate including the attributes “Computer Scientist” AND “Raleigh” but, unfortunately, even with years of history of matching contracts (i.e. sharing the same complex target predicate), the data is likely to be too sparse to produce a statistically reliable sample for a pricing model. However, by mapping this exemplary contract to forecastable user visits, which forecastable user visits are eligible for being displayed advertisements corresponding to other contracts with different target attributes, the data becomes less sparse, possibly to the point of producing a statistically reliable sample for the pricing model.

Another characteristic of techniques used in pricing a contract based on the value of the user visits is that such techniques provide transparency in pricing; that is, an advertiser pays for the impression delivery that the advertiser can reasonably (i.e. within a statistical certainty) expect.

Yet another idea embodied in the herein-disclosed techniques is to leverage the implicit pricing feedback and correction embedded in the current guaranteed sales process. Specifically, guaranteed delivery contracts are sold by salespersons to advertisers and agencies, and there is typically some amount of negotiation that occurs between the parties that results in the final price for the contract being higher or lower than the price quoted by an admission control module (that is, admission control modules that do not include the advances herein disclosed). One observation is that any pricing model that uses the negotiated final prices for recent historical contracts to infer the advertiser's perceived value of user visits will inherently or implicitly encode some information about the market conditions, and/or the willingness of advertisers to pay a given price, etc. Applying this model over time produces a corrective feedback loop by which prices are continually updated. Of course, most negotiations start with some initial offer or price, and a salesperson may receive guidance in the form of an initial offer price from a pricing model (e.g. possibly using an admission control module 115). It remains to discuss how to price individual user visits based on historical contracts. Herein are proposed various alternative techniques to solve this problem, including weighted average and minimum variance price fitting techniques, correspondingly named WAP and MIN-VAR.

### Weighted Average Pricing

Weighted Average Pricing (WAP) postulates that the value of a user visit should be as close as possible to the final negotiated price of each eligible historical contract (normalized by the proportion taken up by each contract). In order to mathematically solve for this objective, it turns out that the value of each user visit is the weighted average price of the prices of eligible historical contracts (hence the term WAP). For example, suppose there was a user visit with an event predicate corresponding to a target predicate of “Computer Scientist living in Raleigh” AND “visiting a Sports page”. If there were two historical contracts interested in the user visit (i.e. the two historical contracts having a matching target predicate), and (historically) 60% of such user visits were supplied to the first contract priced at $1 Cost per “Mille” (CPM) while 40% of such user visits were given to the second contract priced at $4 CPM, then WAP would price the user visit as the weighted average price of the contracts. In this case, the price would be (60%×$1)+(40%×$4)=$2.2 CPM.

### Minimum Variance Pricing

A second technique for pricing user visits attempts to minimize certain variances in the modeling, hence is called MIN-VAR. MIN-VAR postulates that the sum of the values of each eligible user visit should be approximately equal to the price of the contract (notice the subtle difference between this postulate and the WAP postulate). Essentially, MIN-VAR treats each historical price as a soft constraint and tries to find user visit values that, when added up, correspond (within a known variance) to the historical prices. Therefore, application of the MIN-VAR technique attempts to satisfy the constraints to the maximum extent (i.e. minimum variance) possible. Otherwise stated, since there may be many different assignments of prices to user visits that can result in the best possible satisfaction of the constraints, MIN-VAR tries to minimize the variance between the prices of user visits eligible for a matching contract in the absence of any information to the contrary. MIN-VAR thus makes as few assumptions as possible on the user visit prices given the historical contract prices.

### Supply Model and Supply Object

As described herein, the basic unit of supply is an individual user visit, which is identified by a set of event predicates (e.g. attribute-value pairs) that include information about the user and the context of the visit. Specifically, a user-visit may be defined by the following:
User Information is demographic information such as age, gender, income; inferred behavioral attributes such as “interest in sports” or “interest in shopping for car”; geographic information such as country, state, city or zip; etc.
Content Information is information regarding the specific web page visited in the publisher's content hierarchy such as site or section; specific keywords related to the visited web page.
Time Stamp is a time stamp of the user visit (e.g. coded in UTC time format).

Suppose that there are k=1, . . . , K attributes that specify the user and content information, with the set of allowable values for attribute k being denoted by Aₖ. Then, the combination of the user information (expressed as an event predicate) and the content information (also expressed as an event predicate) can be represented as a Boolean expression over the attribute space A₁×A₂× . . . A_{K}. For example, the event predicate of a user visit by a male in the U.S. who is visiting non-Spanish pages with content on the topic of the NBA could be represented as:

(Gender=MaleΛCountry=UsΛLanguage≠SpanishΛContentTopic=NBA)

Suppose that there are k=1, . . . , K attributes that specify the user and content information, with the set of allowable values for attribute k being denoted by Aₖ. It is easily seen that the predicate (in this case, used as an event predicate) could specify any subset of the universe of attribute-values of a user visit, i.e. an element of the set 2^{A}^{₁}^{× . . . ×A}^{_{K}}.

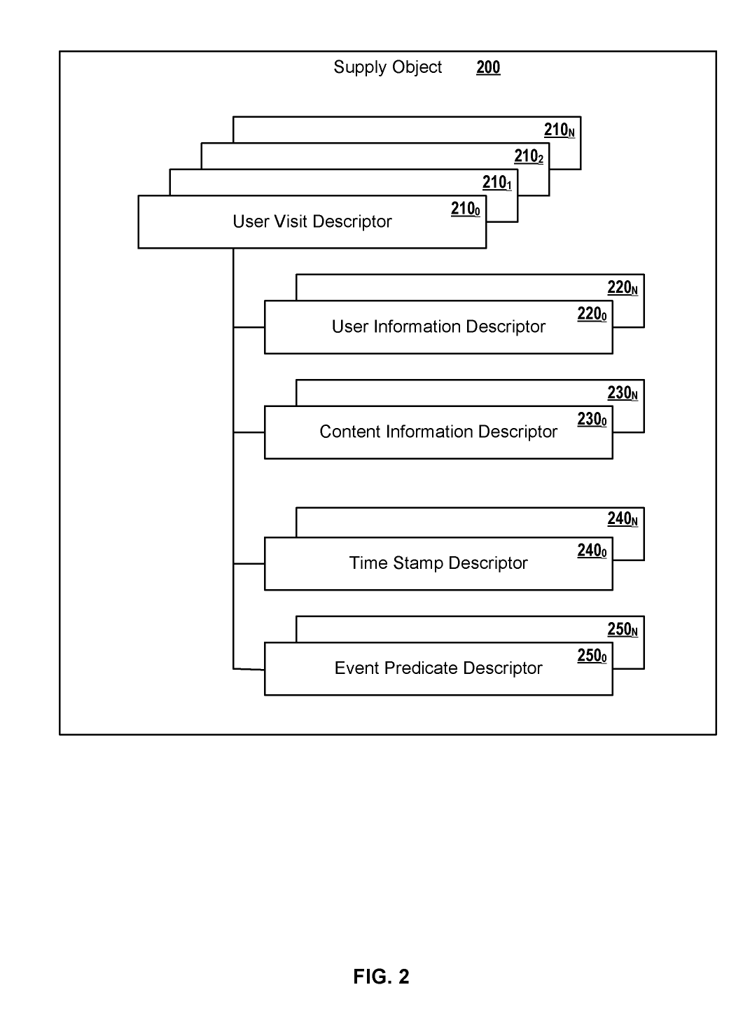

FIG. 2 is a depiction of an exemplary data structure of a supply object 200, according to one embodiment. As described above, an individual user visit may be identified by a set of predicates (e.g. attribute-value pairs) that includes information about the user and the context of the visit. Thus, an exemplary supply object 200 might comprise one or more user visit descriptors 210₀-210_{N}, which in turn may be associated one or more user information descriptors 220₀-220_{N}, one or more content information descriptors 230₀-230_{N}, one or more time stamp descriptors 240₀-240_{N}, and one or more event predicate descriptors 250₀-250_{N}. In some embodiments, an event predicate descriptor might codify an event predicate as a Boolean expression in an appropriate computer-readable form.

### Demand Model and Demand Object

As discussed herein, the basic unit of demand is a guaranteed contract. A guaranteed contract is essentially an agreement that a publisher (or agent) will show an advertisement corresponding to a particular advertiser to a set of users whose attribute-values fall in a subset that is desirable to that advertiser. In more detail, the basic unit of demand is a particular contract, which contract is directly associated with a set of target predicates (e.g. attribute-value pairs) and may include additional information about the goals of the publisher and information describing the advertiser.

In particular, a typical guaranteed-delivery contract (denoted c) may specify the following:
Target Predicate is a Boolean expression over the attribute space A₁×A₂× . . . ×A_{K} that specifies the set of user visits eligible for the contract. For example, the target predicate of a guaranteed contract that targets males in the U.S. who visit non-Spanish pages with content topics NBA or NFL could be represented as:

(Gender∈{Male}ΛCountry∈{US}ΛLanguage∉{Spanish}ΛContentTopic∈{NBA,NFL})

It is easily seen that the target predicate could specify any subset of the universe of attribute-values of a user visit, i.e. an element of the set 2^{A}^{₁}^{× . . . ×A}^{_{K}}.
Flight Duration specifies the start and end times of the query (e.g. coded in UTC time format). For instance, the start time of a query could be 24 May 2010 at 10 am and the end time of the query could be 14 Aug. 2010 at 11 pm.
Impression Goal is the number of user visits for which the advertiser's advertisement needs to be displayed to achieve the impression goal.

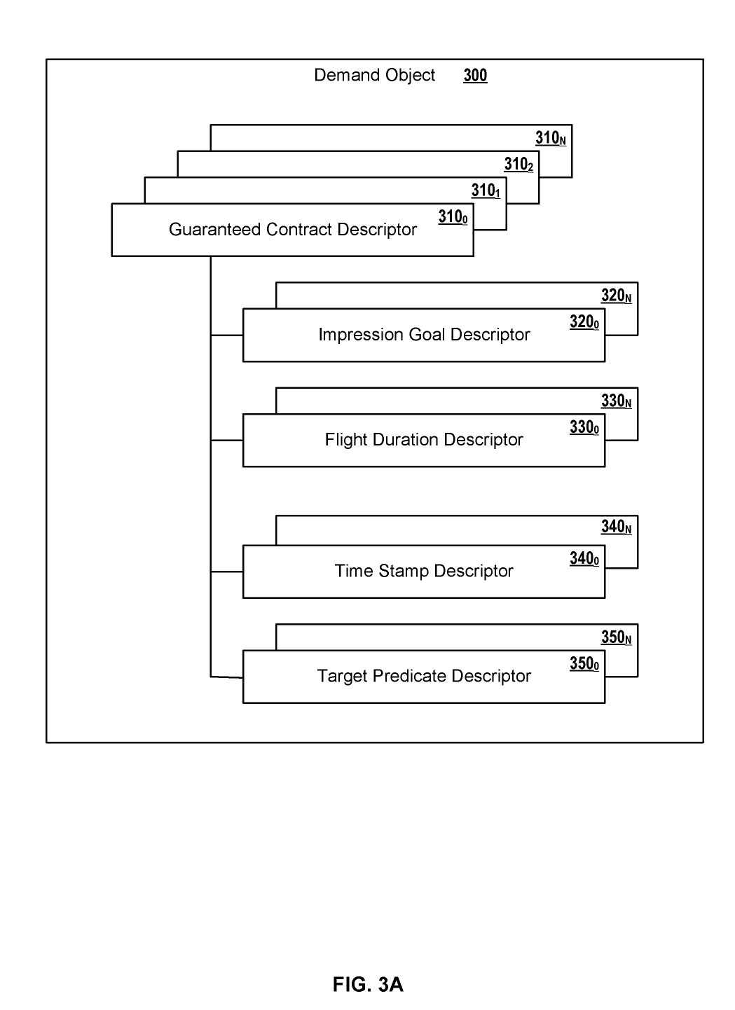

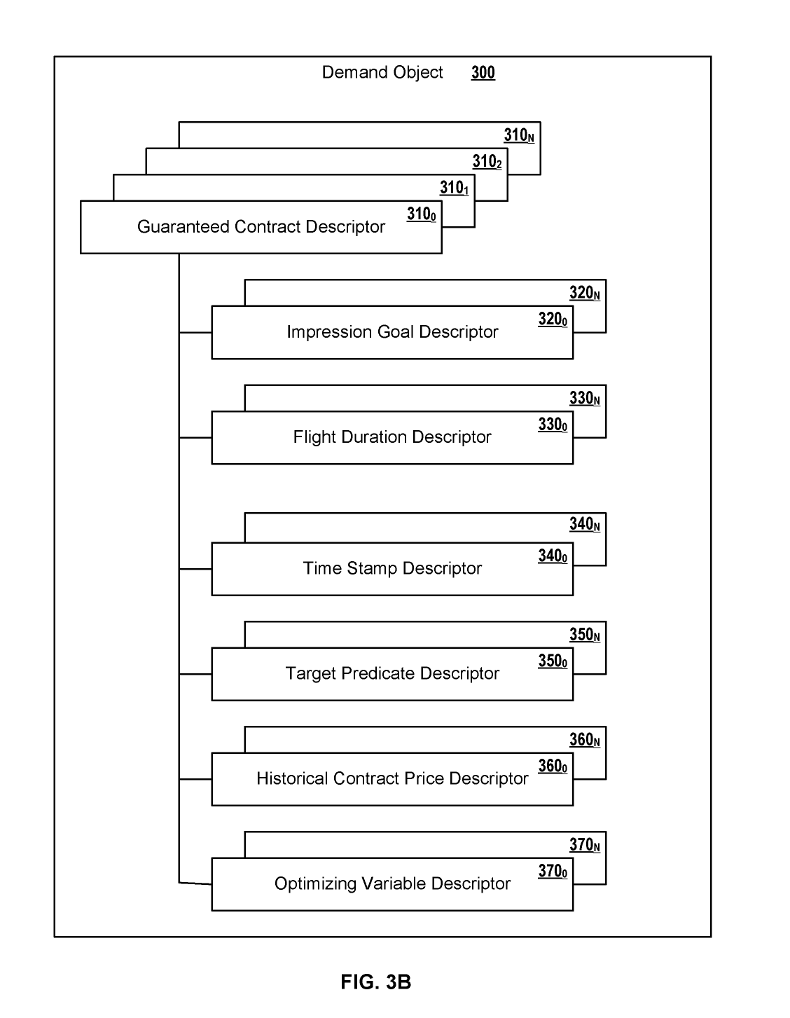

FIG. 3A is a depiction of an exemplary data structure of a demand object 300, according to one embodiment. An exemplary demand object 300 might comprise one or more guaranteed contract descriptors 310₀-310_{N}, which in turn may be directly associated with one or more impression goal descriptors 320₀-320_{N}, one or more flight duration descriptors 330₀-330_{N}, one or more timestamp descriptors 340₀-340_{N}, and one or more target descriptors 350₀-350_{N}.

FIG. 3B is a depiction of an exemplary data structure of a demand object 300, according to another embodiment. An exemplary demand object 300 might comprise one or more guaranteed contract descriptors 310₀-310_{N}, which in turn may be directly associated with one or more historical contract price descriptors 360₀-360_{N}, and one or more optimizing variables coded into optimizing variables descriptors 370₀-370_{N}. In some cases the numerical value of a historical contract price might be calculated based on the measured performance of the contract against its impression goals. In other cases, the value of a historical contract price might be equal to (or be based on) the negotiated final prices for recent historical contracts (which prices might infer the advertiser's perceived value of user visits). In some cases the numerical value of a historical contract price might be calculated based on the predicted performance of the contract against its impression goals, possibly using a forecast of user visits corresponding to the impression goals. Such forecasting is described more fully in the following paragraphs.

Given the above supply and demand models, the problem of pricing guaranteed delivery contracts can be stated as follows: Find an appropriate pricing function Q that maps any allowable combination of target predicate, duration, and impression goal to a corresponding price, i.e.

Q:2^{A}^{₁}^{× . . . ×A}^{_{K}}×[t,t+T]×[t,t+T]×R⁺→R⁺ (EQ. 1)

Stated in this fashion, the scale of the pricing problem becomes evident. A large publisher commonly has many web pages and offers hundreds of different user attributes that advertisers can target. Consequently, the input to the pricing function can be any of the trillions of possible combinations. Note that even though advertisers may not purchase all trillions of the combinations, it is not known a priori in which subset of the combinations they are interested. Consequently, the pricing function should be able to dynamically price any one of the combinations.

### Pricing Based on Expected User Visits

In one embodiment, the price of a subject contract is calculated as the sum of the values of the individual user visits to which the subject contract is expected to be matched.

More formally, the price of a contract is the sum of the values of the expected user visits that will be delivered to that contract. In particular, suppose that an advertisement corresponding to a contract c will be delivered to user visits I_{c} and the price of each user visit i∈I_{c} is pᵢ, then the price q_{c} of the contract c is given by:

$${q}_{c} = {\sum }_{i ∈ {I}_{c}} {p}_{i} \qquad ( EQ . 2 )$$

The intuition behind this idea is the following. Although an advertiser pays a single price for a guaranteed contract, not all of the user visits that the advertiser obtains have the same economic value to the advertiser. For instance, an advertiser who targets users visits to “Yahoo! Finance” web pages may get some user visits corresponding to users from high income New York City zip codes, and some impressions from lower income areas. Even though the advertiser pays for the entire “package”, the economic value of these impressions for advertisers is likely to be very different. Thus, from the advertiser's point of view, a guaranteed contract is a bundle of heterogeneous objects (a mix of more valuable and less valuable user visits). According to various embodiments of the invention herein, the price of a guaranteed contract should reflect the overall weighted value of this mix.

### Handling Product Overlap and Scaling

Pricing based on expected user visits addresses some of the semantic problems associated with traditional yield optimization techniques. For instance, dealing with trillions of seemingly unrelated products that nevertheless overlap can be handled effectively by mapping each product to their corresponding user visits, and using this overlap to guide pricing. For instance, it is possible to determine that the set of eligible user visits for a contract targeting users whose income is above $100,000 a year in the U.S. is almost identical to the set of user visits eligible for a contract targeting users in the large cities of the U.S.

Pricing based on expected user visits also addresses some of the scalability problems of the traditional yield optimization techniques when dealing with trillions of products. That is, although there are many billions of individual user visits, it is sufficient for the purpose of pricing to work with a sample of user visits for each contract. In some cases, a much smaller sample of user visits per contract is often sufficient to calculate prices within a statistical certainty, while the sample of user visits still captures the effects of product overlap. In a sense, this approach may seem almost paradoxical: there are billions of user visits, but only a few hundreds of thousands of booked guaranteed contracts. Yet, it is reasonable to use the prices of individual user visits to price contracts. Even though the number of possible contracts is on the order of trillions of possible contracts, and the number of user visits is on the order of billions of user visits, a small sample of each may yield a statistically meaningful sample size with which to obtain the prices.

Of course, there is still the open issue of how to determine the prices of individual user visits, which is addressed in the following sections.

### Pricing User Visits Based on Historical Contracts

One way to price user visits is to perform calculations using the prices of recent historical contracts. Thus, at least some of the aforementioned corrective feedback and market correction mechanisms inherent in the current guaranteed contract sales process are incorporated into the pricing. More specifically, current guaranteed delivery contracts are typically sold through sales agents interacting either directly with advertisers, or with agencies working on behalf of advertisers. Consequently, the price produced by a pricing engine (e.g. admission control module 115) is used merely as a starting point for negotiations, and can be adjusted upwards or downwards depending on market dynamics, competition, advertisers' willingness to pay, and so on. What this implies, however, is that the final negotiated prices of historical contracts is reached based on various exogenous factors that have an impact on prices. More formally, a pricing function P can be defined to take in a user visit i and a set of matching historical contracts Hᵢ along with their final negotiated prices and other metadata, and output the price of the user visit:

P:i,Hᵢ→R⁺ (EQ. 3)

Of course such a pricing function might include the techniques of WAP and/or the techniques of MIN-VAR, or any other function for that matter.

It is important to note that the approaches contemplated in EQ. 3 do not necessarily result in provably optimal (revenue-wise) final price for a contract. Rather, the goal is to produce a contract price suggestion by taking into account recent marketplace corrections that have been captured in recently negotiated prices.

### Notation

The following two sections describe the WAP and MIN-VAR pricing methods for estimating user visit prices based on historical contract prices. In general, the symbol i is used as a generic identifier for a user visit and the symbol j as a generic identifier for a historical contract. The set of historical contracts used to price user visits is denoted by H and as before, the subset of H that matches a user visit i is denoted by Hᵢ. The final negotiated price for a contract j∈H is denoted qⱼ and the price of a user visit i generated by WAP or MIN-VAR is denoted by pᵢ.

A future contract to be priced (i.e. a subject contract) is denoted as c, thus let I_{c} denote the sampled set of user visits that are forecasted to be delivered to c. Since the user visits in I_{c} have time stamps in the future, in practice a time stamp occurring in the future might be translated into a time stamp in the past in order to find a set of matching historical contracts. Here, for simplicity of notation, let Hᵢ denote the set of historical contracts matching a future user visit i∈I_{c} with the implicit understanding that the user visit i has been translated back in time to find the matching historical contracts. Of course, there are many techniques for finding matching historical contracts that match a user visit (e.g. a future user visit i∈I_{c}). One such technique involves use of an inverted index such that an event predicate (corresponding to a particular user visit) is used to match a target predicate (corresponding to a particular contract).

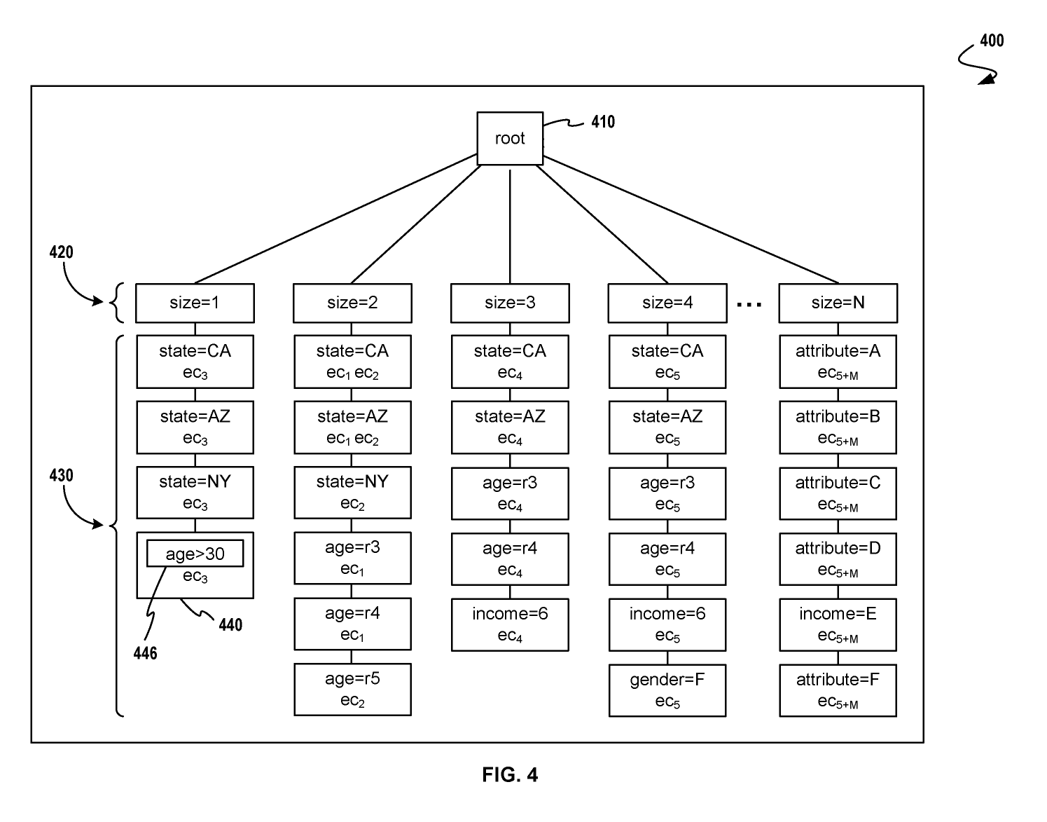

FIG. 4 shows an index with target predicates in the form of an inverted index 400. As an option, the inverted index may be implemented in the context of the architecture and functionality of the embodiments described herein. Of course, however, the index with target predicates or any portion therefrom may be used in any desired environment. As shown, an index with target predicates in the form of an inverted index 400 comprises a tree structure stemming from an inverted index root 410 into the inverted index branches 420 (labeled as size=1, size=3, . . . size=N) under which inverted index branches 420 are index predicate nodes 430. In the particular embodiment shown, the index predicate nodes 430 are labeled with a target predicate (e.g. state=CA, state=AZ, etc) and with corresponding labels indicating one or more particular contracts (e.g. ec₁, ec₂, ec₃, etc) that might be satisfied (e.g. matched, at least in part) with respect to the target predicate of that node. For example, for the sample node 440, contract ec₃ might be eligible (at least in part) to be served to a particular user visit when the example target predicate 446 age>30 matches the particular user visit with a corresponding event predicate (e.g. the user is of age>30). Of course, the foregoing structure is only an illustrative example, and other structures are reasonable and envisioned.

In more formal terms, one might say that a user visit i∈I is eligible for contract c∈H if, and only if, it satisfies the target predicates of c. It can also sometimes be said that c is eligible for i in this case.

Thus, it can be understood that, using an inverted index (or other contract matching technique), a particular user visit can be matched to any number of eligible contracts.

### WAP Pricing

WAP pricing is based on the following: The price of each user visit is as close as possible to the final negotiated price of an eligible historical contract (normalized by the number of impressions). Of course, a user visit may have multiple eligible historical contracts and, in this case, one curve-fitting technique is to select a price such that the deviation is as small as possible across all of these contracts.

### Formal Model

The WAP price for a user visit is obtained by minimizing a weighted least squares objective function, where the prices of historical contracts are the independent variables and the price of the user visit is the dependent variable. That is, given a user visit i and a set of eligible historical contracts Hᵢ⊂H , the price pᵢ is obtained by:

$${p}_{i} ∈ arg {min}_{p \geq 0} \{ {\sum }_{j ∈ {H}_{i}} {{x}_{ij} ( {q}_{j} - p )}^{2} \} \qquad ( EQ . 4 )$$

Here, xᵢⱼ≧0 is a weight that captures the importance of contract j in determining the price of i, and is used to capture the fact that not all historical contracts may have the same influence on the price of a user visit. For instance, a narrowly targeted eligible contract that targets a small number of user visits is likely to have a larger impact on the user visit price than a contract that targets potentially billions of user visits. One way of capturing this weight systematically is to view it as an ad serving probability, i.e. the probability that the ad server will serve a user visit such as i to a contract j.

### Solving for User Visit Prices

There are many techniques for efficiently solving for user visit prices that meet the above objective. Since the objective function to be minimized (i.e. the right hand side of EQ. 4) is a simple quadratic function of p, the price pᵢ can be written in closed form as:

$$\begin{matrix}{p}_{i} = max \{ \frac{{\sum }_{j ∈ {H}_{i}} {x}_{ij} {q}_{j}}{{\sum }_{j ∈ {H}_{i}} {x}_{ij}} , 0 \} \\ = \frac{{\sum }_{j ∈ {H}_{i}} {x}_{ij} {q}_{j}}{{\sum }_{j ∈ {H}_{i}} {x}_{ij}}\end{matrix} \qquad ( EQ . 5 )$$

since qⱼ,xᵢⱼ≧0 for each j∈Hᵢ. Thus, the user visit price pᵢ can be simply computed using the above formula. Having calculated the pᵢ for all i∈I_{c}, the price per user visit for contract c is calculated using (EQ. 2).

### MIN-VAR Pricing

The MIN-VAR algorithm adopts a subtly different approach than WAP, as described in the following: The price of the sum of eligible user visits is as close as possible to the final negotiated price of a historical contract. Accordingly, the MIN-VAR algorithm solves a linear regression model to infer the prices of individual user visits from the prices of the historical contracts.

### Formal Model

Assume that for each contract j∈H , there exists a sampled set of user visits eligible to be served (e.g. displayed) to j. This sampled set of user visits is denoted as I^{H}. For each such user visit i∈I^{H}, let μᵢ denote the “weight” of the user visit i in the sample. In this sense, μᵢ represents the number of user visits that are represented by the single user visit i in the sample. As in the case of WAP, let xᵢⱼ denote the ad server probability that the user visit i will be served to a contract j. Now, define the total number of user visits that will be served to contract j as:

$${D}_{j} := {\sum }_{i : j ∈ {H}_{i}} {μ}_{i} {x}_{ij}$$

Then, the MIN-VAR algorithm solves the following optimization problem to determine the price of a user visit i:

$$min {\sum }_{j ∈ H} \{ {\sum }_{i : j ∈ {H}_{i}} {μ}_{i} {{x}_{ij} ( {p}_{i} {q}_{j} )}^{2} + {WD}_{j} {z}_{j}^{2} \} \\ s . t . {\sum }_{i : j ∈ {H}_{i}} {μ}_{i} {x}_{ij} {p}_{i} + {D}_{j} {z}_{j} = {q}_{j} {D}_{j} ∀ j ∈ H \\ {p}_{i} \geq 0 ∀ i ∈ {I}^{H} \qquad ( EQ . 6 )$$

In narrative, the objective function is the weighted sum (with W being the relative weight) of two different functions. Ignoring the first term in the objective involving the user visit prices pᵢ, what remains is a traditional least squares optimization problem that tries to fit the user visit prices to add up, as close as possible, to the negotiated contract prices. However, there could be multiple sets of user visit prices that would minimize the error in fit to the contract prices (i.e. multiple optimal solutions).

In order to choose between multiple optimal solutions, it is possible to use an approach similar to entropy maximization. In particular, entropy maximization can be used to choose a solution where the variation in the prices of all the user visits that served a particular contract to be as small as possible (hence the name MIN-VAR). Stated differently, unless there is specific information forcing the prices of any two user visits to be different, a chosen optimization would prefer their prices to be equal. To achieve this objective, add the term:

$${\sum }_{i : j ∈ {H}_{i}} {μ}_{i} {{x}_{ij} ( {p}_{i} - {q}_{j} )}^{2} \qquad ( Term 7 )$$

for each contract j. This term (Term 7) models the variance (relative to the contract price) of the individual user visit prices used to serve the contract.

### Relationship to WAP Pricing

Note the relationship between the WAP and MIN-VAR algorithms. Consider for a moment the objective function in EQ. 6 with the value of W set to zero, that is with W=0. This can be written as:

$$min {\sum }_{j ∈ H} {\sum }_{i \text{:} j ∈ {H}_{i}} {μ}_{i} {{x}_{ij} ( {p}_{i} - {q}_{j} )}^{2} = min {\sum }_{i ∈ {\vert}^{H}} {μ}_{i} \{ {\sum }_{j ∈ {H}_{i}} {{x}_{ij} ( {p}_{i} - {q}_{i} )}^{2} \} \qquad ( EQ . 7 )$$

It is easily seen that for each individual user visit i, the MIN-VAR objective function is exactly the same as the WAP objective function, since for W=0 the individual user visit prices generated by the WAP and MIN-VAR algorithms are identical.

### Solving for User Visit Prices

There exist many techniques for efficiently computing user visit prices that satisfy the MIN-VAR objective. One such technique would be to solve the problem in two stages, i.e. first solve the regression problem and then find the minimum variance solution among the set of optimal solutions to the regression problem. However, underdetermined regression techniques are highly susceptible to outliers in the data; that is, even a single contract with an anomalous price could act to skew the prices of all of that contract's eligible user visits. To mitigate this problem, a second technique involves solving for both objectives together using a relative weight W that is tuned (e.g. based on calculations using empirical data) so as to be resistant to outliers, while at the same time calculating the fitting of user visit prices against the historical contract prices.

Another technique accounts for the fact that within MIN-VAR (unlike WAP), the price of a user visit is related to the price of other user visits eligible for the historical contracts, including those user visits that may not even be eligible for the new contract being priced. The motivation for this technique is as follows: In a naïve approach, the problem needs to be solved for a large set of user visits that are only indirectly related to the contract being priced, and it is typically impractical to solve this problem online to produce a price for the sales agent. However, solving and storing the user visit prices offline also has its challenges because it is typically impractical to compute user visit prices for every possible sample that might be requested for the trillions of products.

The proposed technique proceeds in two steps. In the first (possibly offline) step, solve the problem of EQ. 6 with a sample of user visits relevant to the historical contracts (and not including the new contract to be priced). Based on this solution, store the optimal dual values (denoted by βⱼ*) per contract corresponding to each equality constraint in EQ. 6. In the second (possibly online) step, given a set of user visits expected to be served to the contract to be priced, use the stored βⱼ* values for the historical contracts to rapidly compute the price for each new user visit. This two step technique apportions much of the intensive computation to the first (possibly offline) step, and still enables rapid computation of the user visit prices in the second (possibly online) step.

Yet another technique described below can quickly compute the user visit prices online using the dual values of the optimal solution (the βⱼ* values). From the duality theory for convex optimization problems, it can be shown that given an optimal vector β*:=(βⱼ*:j∈H) of Lagrange multipliers for the equality constraints of EQ. 6, any vector p:=(pᵢ:i∈H) such that p≧0 and vector z:=(zⱼ:i∈H) is an optimal set of user visit prices (and slacks) in EQ. 6 if and only if the following complimentary slackness condition holds:

$$( p , z ) ∈ arg {min}_{p \geq 0} L ( p , z , {β}^{*} ) \qquad ( EQ . 8 )$$

where for any p, z and β the Lagrangian function L(p,z,β) is defined as:

$$L ( p , z , β ) := {\sum }_{j ∈ H} \{ {\sum }_{i : j ∈ {H}_{i}} {μ}_{i} {{x}_{ij} ( {p}_{i} - {q}_{j} )}^{2} + {WD}_{j} {z}_{j}^{2} \} - {\sum }_{j ∈ H} {β}_{j} \{ {\sum }_{i : j ∈ {H}_{i}} {μ}_{j} {x}_{ij} {p}_{i} + {D}_{j} {z}_{j} - {D}_{j} {q}_{j} \} \qquad ( EQ . 9 )$$

Rearranging the terms of EQ. 9 and using EQ. 8:

$${min}_{p \geq 0} L ( p , z , {β}^{*} ) = {\sum }_{i ∈ {\vert}^{H}} {μ}_{i} {min}_{{p}_{i} \geq 0} {\sum }_{j ∈ {H}_{i}} \{ {{x}_{ij} ( {p}_{i} - {q}_{j} )}^{2} - {β}_{j}^{*} {x}_{ij} {p}_{i} \} + {\sum }_{j ∈ H} {min}_{{z}_{j}} \{ {D}_{j} ( {Wz}_{j}^{2} - {β}_{j}^{*} {z}_{j} ) \} + {β}_{j}^{*} {D}_{j} {q}_{j} \qquad ( EQ . 10 )$$

EQ. 10 can be solved in closed form individually for each pᵢ and zⱼ. Thus, from EQ. 10 the optimal user visit prices pᵢ and the slacks zⱼ can be obtained from the optimal βⱼ* values using:

$$\begin{matrix}{p}_{i} := max \{ 0 , \frac{{\sum }_{j ∈ {H}_{i}} ( {q}_{j} + \frac{{β}_{j}^{*}}{2} ) {x}_{ij}}{{\sum }_{j ∈ {H}_{i}} {x}_{ij}} \} \\ and & ( EQ . 11 ) \\ {z}_{j} := \frac{{β}_{j}^{*}}{2 W} & ( EQ . 12 )\end{matrix}$$

Thus, the above equation might be used to compute the user visit prices. Once the user visit prices are computed, the contract price is then computed using EQ. 2.

### Exemplary System Architectures

### WAP and MIN-VAR Algorithms

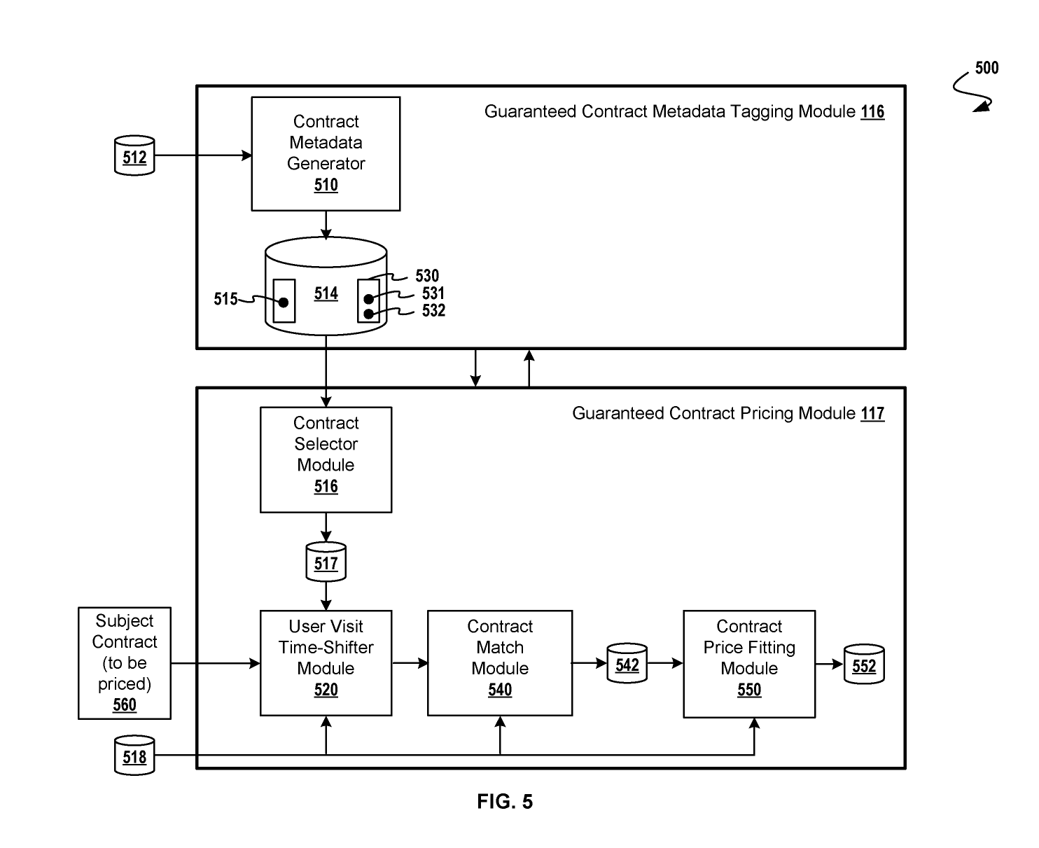

FIG. 5 depicts a portion of an advertising server network environment including modules for pricing guaranteed delivery contracts in online display advertising. As shown, for each subject contract 560 to be priced, the pricing system receives a set of user visits 518 I_{c}, which set of user visits are a sample of forecastable user visits that are eligible to be served to the subject contract. In some embodiments, the sample of forecastable user visits is obtained from a supply forecasting system (e.g. forecasting module 111), which supply forecasting system might be used for booking guaranteed contracts, in turn, possibly using any one or more modules (e.g. a contract metadata generator 510) within a guaranteed contract metadata tagging module 116. The contract metadata generator 510 operates on an appropriate set of recent historical contracts 512 j∈H (possibly using the facilities of a storage of contracts module 110) and populates an annotated historical contract database 514 with the final negotiated price qⱼ, the quantity αⱼ, and the quantity βⱼ*. That is, an annotated historical contract database 514 might be annotated to contain historical prices 515 for any/all of the contracts therein. In some cases an annotated historical contract database 514 might be annotated to contain an annotation of one or more optimizing variables 530, for example a heuristic probability 531, or an optimal dual value 532, the heuristic probability 531 being an approximation of the probability that a user visit will be served to the corresponding contract.

The quantity αⱼ (e.g. a heuristic probability 531) is evaluated as αⱼ=(Dⱼ/Sⱼ) where Dⱼ denotes the set of number of user visits delivered to contract j and Sⱼ denotes the total number of user visits eligible for contract j. This ratio αⱼ might be used as a heuristic approximation for the probability xᵢⱼ that any user visit will be served to contract j. The intuition is that if the total number of user visits demanded by a contract is very close to the total number of eligible user visits, then any particular eligible user visit does indeed have a high probability of being delivered to that contract. For the MIN-VAR algorithm, the contract metadata generator 510 also stores in an annotated historical contract database 514 the optimal dual values βⱼ* (e.g. an optimal dual value 532) from solving EQ. 6. Now, regarding the guaranteed contract pricing module 117, when a set of user visits 518 I_{c} is sent to the guaranteed contract pricing module 117, the user visit time-shifter module 520 first translates the time stamps of each user visit back in time to the period when the selected contracts 517 in H were active. A database of such selected contracts 517 might possibly be selected using a contract selector module 516. Then, for each such user visit within the set of user visits 518 (after being time-shifted as needed), contract match module 540 returns a set of eligible historical contracts 542 along with the qⱼ, αⱼ and βⱼ* values. Setting xᵢⱼ=αⱼ, the contract price fitting module 550 uses either EQ. 13 (for WAP) or EQ. 14 (for MIN-VAR) to find the curve fitted price of each user visit. That is, such that pᵢ for WAP:

$${p}_{i} = \frac{{\sum }_{j ∈ {H}_{i}} {α}_{j} {q}_{j}}{{\sum }_{j ∈ {H}_{i}} {α}_{j}} \qquad ( EQ . 13 )$$

Or, that is, such that pᵢ for MIN-VAR:

$${p}_{i} := max \{ 0 , \frac{{\sum }_{j ∈ {H}_{i}} ( {q}_{j} + \frac{{β}_{j}^{*}}{2} ) {α}_{j}}{{\sum }_{j ∈ {H}_{i}} {α}_{j}} \} \qquad ( EQ . 14 )$$

Then, the price q_{c} of the subject contract is calculated as earlier described in EQ. 2:

$${q}_{c} = {\sum }_{i ∈ {\vert}_{c}} {p}_{i} \qquad ( EQ . 2 )$$

Then, having the curve fitting operations may be performed so as to find a best fit (i.e. optimized price using WAP or MIN-VAR) for the subject contract, the optimized price may be reported, possibly using a database 552.

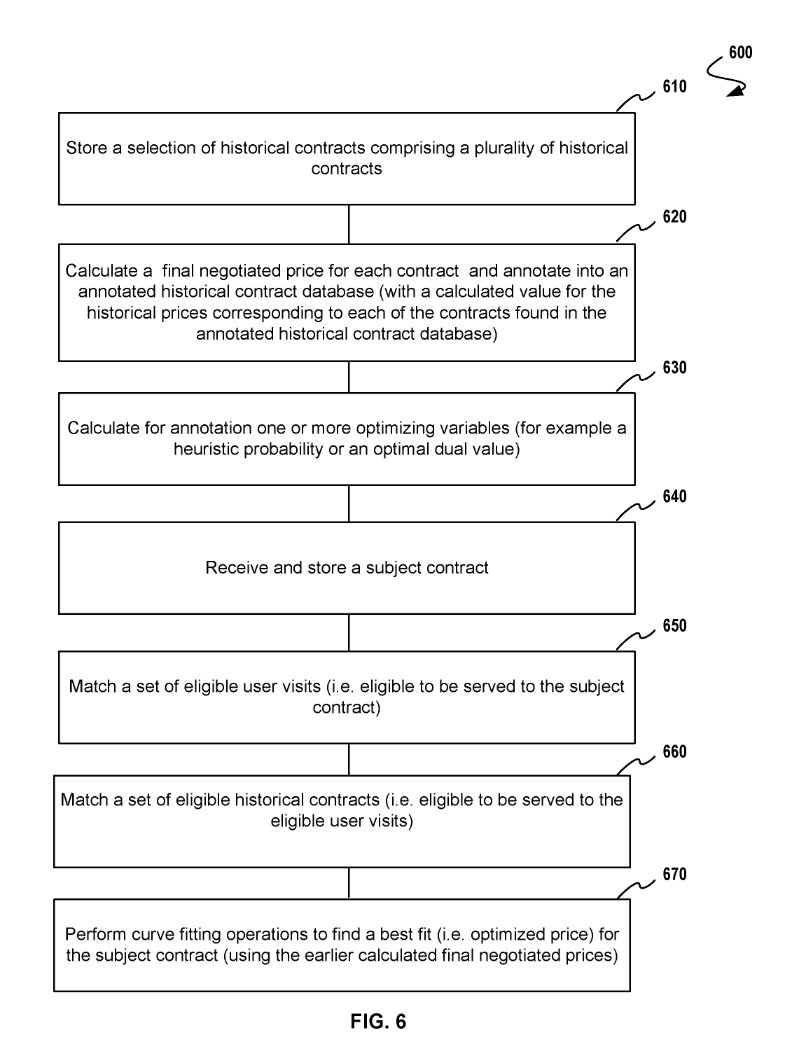

FIG. 6 shows a method for pricing guaranteed delivery contracts in an online display advertising environment. As an option, the present method 600 may be implemented in the context of the architecture and functionality of the embodiments described herein. Of course, however, the method 600 or any operation therein may be carried out in any desired environment. The operations can, individually or in combination, perform any steps within method 600. Any method steps performed within method 600 may be performed in any order unless as may be specified in the claims. As shown, method 600 implements a method for pricing guaranteed delivery contracts in an online display advertising environment, the method 600 comprising storing a selection of historical contracts comprising a plurality of historical contracts (see operation 610). This operation might be implemented in a guaranteed contract metadata tagging module 116. The method continues by calculating a value known as the final negotiated price for each contract (see operation 620). In the example shown, the final negotiated price (e.g. historical prices 515) might be calculated and annotated into an annotated historical contract database 514, with a calculated value for the historical prices 515 corresponding to each of the contracts found in the annotated historical contract database 514. In some cases the method 600 might also calculate for annotation one or more optimizing variables 530, for example a heuristic probability 531, or an optimal dual value 532, the heuristic probability 531 being an approximation of the probability that a user visit will be served to the corresponding contract (see operation 630). In some other cases the method 600 might also calculate for annotation an optimal dual value 532—the optimal dual value 532 determined from solving an optimization function subject to one or more equality constraints (again, see operation 630). At some point in time the method 600 may receive and store a subject contract (see operation 640), which subject contract is used in matching a set of user visits 518 (see operation 650). Then, for each such user visit within the set of user visits 518, a matching operation returns a set of eligible historical contracts 542 (see operation 660). Having now a set of eligible historical contracts 542 together with their annotations (again see operation 620 and operation 630) any one or more curve fitting operations may be performed so as to find a best fit (i.e. optimized price) for the subject contract, the optimized price may be reported, possibly using a database 552 (see operation 670).

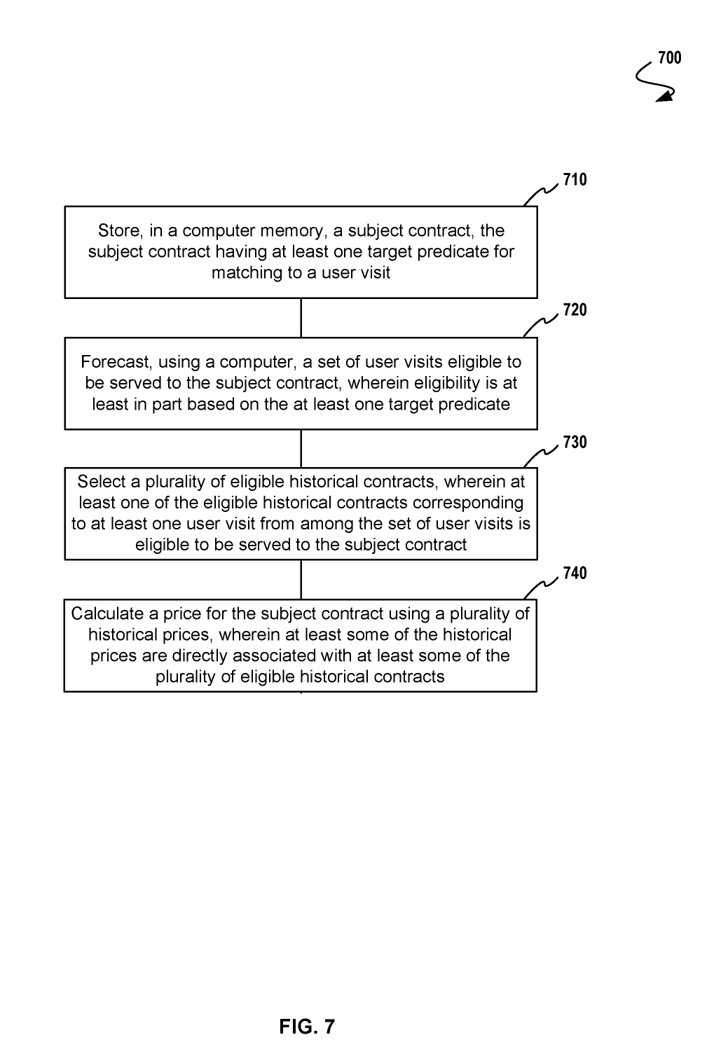

FIG. 7 depicts a block diagram of a method for pricing a subject contract in online display advertising. As an option, the present method 700 may be implemented in the context of the architecture and functionality of the embodiments described herein. Of course, however, the method 700 or any operation therein may be carried out in any desired environment. The operations of the method can, individually or in combination, perform method steps within method 700. Any operations performed within method 700 may be performed in any order unless as may be specified in the claims. As shown, method 700 implements a method for pricing a subject contract in online display advertising, the method 700 comprising operations for: storing, in a computer memory, a subject contract, the subject contract having at least one target predicate for matching to a user visit (see operation 710); forecasting, using a computer, a set of user visits eligible to be served to the subject contract, wherein eligibility is at least in part based on the at least one target predicate (see operation 720); selecting a plurality of eligible historical contracts, wherein at least one of the eligible historical contracts corresponding to at least one user visit from among the set of user visits is eligible to be served to the subject contract (see operation 730); and calculating a price for the subject contract using a plurality of historical prices, wherein at least some of the historical prices are directly associated with at least some of the plurality of eligible historical contracts (see operation 740).

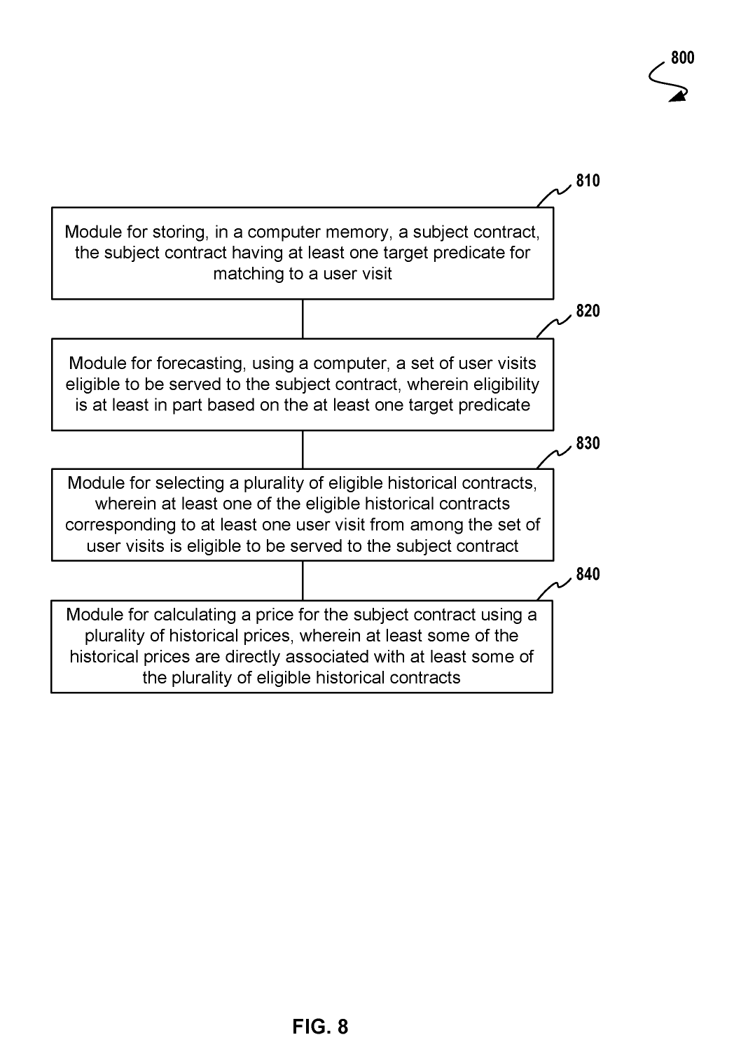

FIG. 8 depicts a block diagram of a system to perform certain functions of an advertising server network. As an option, the present system 800 may be implemented in the context of the architecture and functionality of the embodiments described herein. Of course, however, the system 800 or any operation therein may be carried out in any desired environment. As shown, system 800 comprises a plurality of modules including a processor and a memory, each module connected to a communication link 805, and any module can communicate with any other modules over communication link 805. The modules of the system can, individually or in combination, perform method steps within system 800. Any method steps performed within system 800 may be performed in any order unless as may be specified in the claims. As shown, FIG. 8 implements an advertising server network as a system 800, comprising modules including a module for storing, in a computer memory, a subject contract, the subject contract having at least one target predicate for matching to a user visit (see module 810); a module for forecasting, using a computer, a set of user visits eligible to be served to the subject contract, wherein eligibility is at least in part based on the at least one target predicate (see module 820); a module for selecting a plurality of eligible historical contracts, wherein at least one of the eligible historical contracts corresponding to at least one user visit from among the set of user visits is eligible to be served to the subject contract (see module 830); and a module for calculating a price for the subject contract using a plurality of historical prices, wherein at least some of the historical prices are directly associated with at least some of the plurality of eligible historical contracts (see module 840).

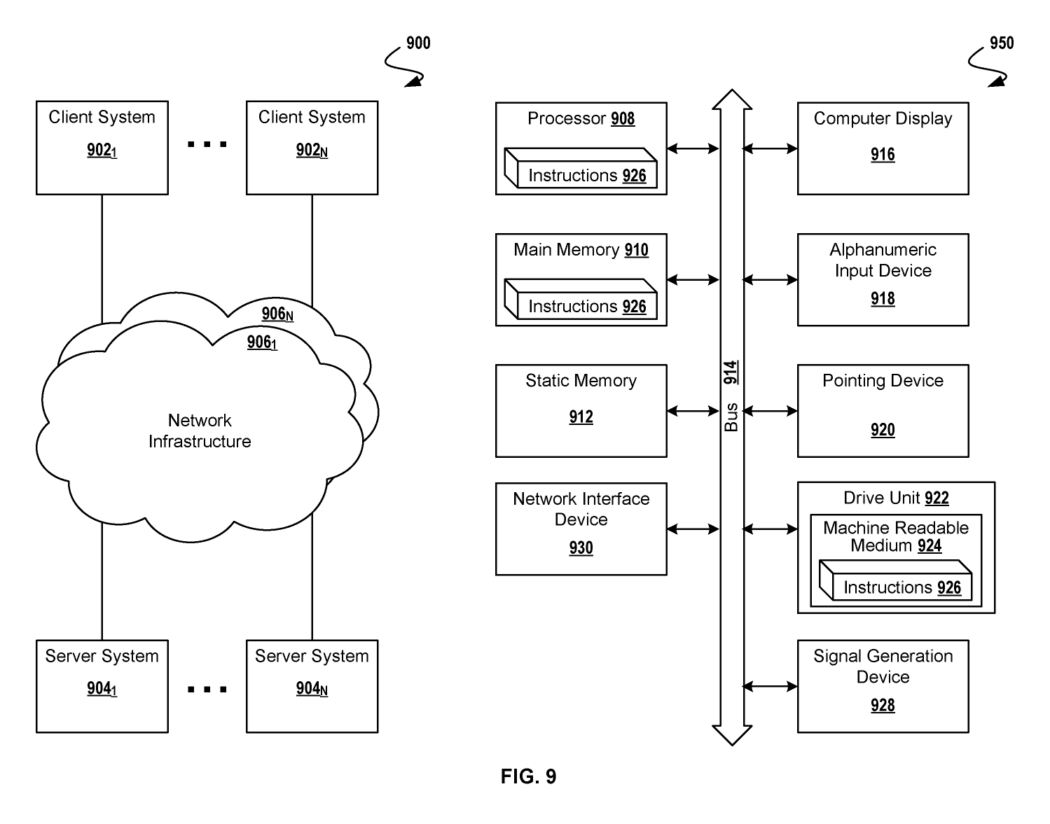

FIG. 9 is a diagrammatic representation of a network 900, including nodes for client computer systems 902₁ through 902_{N}, nodes for server computer systems 904₁ through 904_{N}, nodes for network infrastructure 906₁ through 906_{N}, any of which nodes may comprise a machine (e.g. computer 950) within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system (e.g. computer 950) includes a processor 908 (e.g. a processor core, a microprocessor, a computing device, etc), a main memory (e.g. computer memory 910) and a static memory 912, which communicate with each other via a bus 914. The computer 950 may further include a display unit (e.g. computer display 916) that may comprise a touch-screen, or a liquid crystal display (LCD), or a light emitting diode (LED) display, or a cathode ray tube (CRT). As shown, the computer system also includes a human input/output (I/O) device 918 (e.g. a keyboard, an alphanumeric keypad, etc), a pointing device 920 (e.g. a mouse, a touch screen, etc), a drive unit 922 (e.g. a disk drive unit, a CD/DVD drive, a tangible computer readable removable media drive, an SSD storage device, etc), a signal generation device 928 (e.g. a speaker, an audio output, etc), and a network interface device 930 (e.g. an Ethernet interface, a wired network interface, a wireless network interface, a propagated signal interface, etc).

The drive unit 922 includes a machine-readable medium 924 on which is stored a set of instructions (i.e. software, firmware, middleware, etc) 926 embodying any one, or all, of the methodologies described above. The set of instructions 926 is also shown to reside, completely or at least partially, within the main memory and/or within the processor 908. The set of instructions 926 may further be transmitted or received via the network interface device 930 over the network bus 914.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for pricing a contract in online display advertising comprising:
storing, in a computer memory, a subject contract having at least one target predicate for matching to a user visit;
forecasting, using a computer, a set of user visits eligible to be served to the subject contract, wherein eligibility is at least in part based on the target predicate;
selecting a plurality of eligible historical contracts, at least one of the eligible historical contracts corresponding to at least one user visit from among the set of user visits eligible to be served to the subject contract; and
calculating a price for the subject contract using a plurality of historical prices, at least some of the historical prices directly associated with at least some of the plurality of eligible historical contracts.

2. The method of claim 1, further comprising storing, in a computer memory a final negotiated price for at least one of the plurality of eligible historical contracts.

3. The method of claim 1, wherein the at least one target predicate is a Boolean expression.

4. The method of claim 1, wherein the forecasting includes forecasting user visits that are eligible for being served to at least one contract other than the subject contract.

5. The method of claim 1, wherein the selecting a plurality of eligible historical contracts includes a time shifter.

6. The method of claim 1, wherein the selecting a plurality of eligible historical contracts includes selecting at least one eligible historical contracts coded with the qⱼ value.

7. The method of claim 1, wherein the selecting a plurality of eligible historical contracts includes selecting at least one eligible historical contracts coded with at least one optimizing variable.

8. The method of claim 1, wherein the calculating a price for the subject contract using a plurality of historical prices includes a curve fitting operation.

9. The method of claim 1, wherein the calculating a price for the subject contract using a plurality of historical prices includes a WAP curve fitting operation.

10. The method of claim 1, wherein the calculating a price for the subject contract using a plurality of historical prices includes a MIN-VAR curve fitting operation.

11. An advertising server network for pricing a contract in online display advertising comprising:
a module for storing, in a computer memory, a subject contract the subject contract having at least one target predicate for matching to a user visit;
a module for forecasting, using a computer, a set of user visits eligible to be served to the subject contract, wherein eligibility is at least in part based on the at least one target predicate;
a module for selecting a plurality of eligible historical contracts, at least one of the eligible historical contracts corresponding to at least one user visit from among the set of user visits eligible to be served to the subject contract; and
a module for calculating a price for the subject contract using a plurality of historical prices, at least some of the historical prices directly associated with at least some of the plurality of eligible historical contracts.

12. The advertising server network of claim 11, further comprising storing, in a computer memory a final negotiated price for at least one of the plurality of eligible historical contracts.

13. The advertising server network of claim 11, wherein the at least one target predicate is a Boolean expression.

14. The advertising server network of claim 11, wherein the forecasting includes forecasting user visits that are eligible for being served to at least one contract other than the subject contract.

15. The advertising server network of claim 11, wherein the selecting a plurality of eligible historical contracts includes a time shifter.

16. The advertising server network of claim 11, wherein the selecting a plurality of eligible historical contracts includes selecting at least one eligible historical contracts coded with the qⱼ value.

17. The advertising server network of claim 11, wherein the selecting a plurality of eligible historical contracts includes selecting at least one eligible historical contracts coded with at least one optimizing variable.

18. The advertising server network of claim 11, wherein the calculating a price for the subject contract using a plurality of historical prices includes a curve fitting operation.

19. The advertising server network of claim 11, wherein the calculating a price for the subject contract using a plurality of historical prices includes a WAP curve fitting operation.

20. A computer readable medium comprising a set of instructions which, when executed by a computer, cause the computer to price a contract in online display advertising, the set of instructions for:
storing, in a computer memory, a subject contract having at least one target predicate for matching to a user visit;
forecasting, using a computer, a set of user visits eligible to be served to the subject contract, wherein eligibility is at least in part based on the target predicate;
selecting a plurality of eligible historical contracts, at least one of the eligible historical contracts corresponding to at least one user visit from among the set of user visits eligible to be served to the subject contract; and
calculating a price for the subject contract using a plurality of historical prices, at least some of the historical prices directly associated with at least some of the plurality of eligible historical contracts.
